(19) United States
(12) Patent Application Publication
(10) Pub. No.: US 2026/0364552 A1
(43) Pub. Date: Nov. 19, 2026

(54) MAGNETIC MIXING SYSTEM FOR BEVERAGE CONTAINERS

(71) Applicant: Joseph Russo, JR., Orlando, FL (US)

(72) Inventor: Joseph Russo, JR., Orlando, FL (US)

(21) Appl. No.: 19/637,449

(22) Filed: Apr. 2, 2026

Related U.S. Application Data
(60) Provisional application No. 63/805,060, filed on May 13, 2025.

(51) Int. Cl. B01F 35/222; B01F 23/43; B01F 33/452; B01F 35/32; B01F 101/14

(52) U.S. Cl. CPC B01F 35/222; B01F 23/43; B01F 33/452; B01F 35/3204; B01F 2101/14

(57) ABSTRACT

A mixing system includes a stirring bar and magnetic mixing device having a plurality of internally located magnetic drives. Each of the magnetic drives are positioned equidistantly from the center of the device body and generate an axial flux that extends upward from the top surface of the device body. The device functions in a single operating mode wherein the stirring bar rotates around the central axis of the magnetic field generated by a single active magnetic drive to stir a liquid filled container. The device also functions in a cumulative operating mode wherein the stirring bar rotates around the central axis of the device within overlapping magnetic fields generated by multiple magnetic drives operating at the same time to stir the liquid within the container. A controller switches the device between the operating modes to move the location of the stirrer within the liquid filled container.

### CROSS-REFERENCE TO RELATED APPLICATIONS

This application claims the benefit of U.S. application Ser. No. 63/805,060 filed on May 13, 2025, the contents of which are incorporated herein by reference.

### TECHNICAL FIELD

The present invention relates generally to the field of cocktail beverage dispensing systems, and more particularly to a magnetic system for mixing beverages within a container.

### BACKGROUND

The statements in this section merely provide background information related to the present disclosure and may not constitute prior art.

Many bars and restaurants are increasingly utilizing beverage dispensing systems to provide mixed cocktails to their customers. Unlike beer, these cocktails must be periodically mixed to prevent the drink components from separating and/or diminishing in flavor. As such, one existing system utilizes a stirring bar (commonly referred to as a “pill”) that is positioned within a container housing the beverage to be stirred and dispensed.

The container is positioned onto a stand that includes an internal motor, plate, and magnet. The plate and magnet are positioned within the center of the stand and are magnetically attracted to the pill inside the beverage container. The motor is mechanically connected to the plate and operates to rotate the plate and the magnet. Owing to the magnetic attraction with the pill, this rotation causes the pill to rotate within the beverage container and stir the beverage.

Although useful, this system suffers from several practical drawbacks. For example, it is not uncommon for the pill to periodically move from the center of the container and to lose its connection with the magnet. When this happens, the pill will stop spinning, fall to the bottom of the container, and stop stirring the beverage. Unfortunately, because the beverage containers (and the beverages themselves) are not clear, there is no way for a user to know if/when such a situation happens.

Moreover, there is no mechanism to automatically realign the pill and plate. As such, many users routinely disconnect and manually reconnect the container, pill and stand components to ensure the pill and magnet are aligned. This process is time consuming and difficult, as it requires a user to physically lift, tilt, rotate or otherwise manhandle the container to position the pill in the center so that it is aligned (or realigned) with the center of the stand beneath which the magnet is located.

As noted above, users do not know if/when the pill and magnet lose connection, so many times this process is performed needlessly. Another issue is that when used with beverage systems, it is necessary for the components to operate continuously. As such, the motor and bearings that physically engage and spin the plate fail quite often, thus causing the user to incur high maintenance or replacement costs, along with the high-power consumption of the same.

Accordingly, it would be beneficial to provide a system for mixing beverages within a container that does not suffer from the drawbacks noted above.

### SUMMARY OF THE INVENTION

The present invention is directed to a magnetic mixing system for beverage containers. One embodiment of the present invention can include a stirring bar and a magnetic mixing device. The mixing device can include a main body and a plurality of internally located magnetic drives. Each of the magnetic drives can be positioned in a radial orientation equidistantly from the center of the device body and can function to generate an axial flux that extends upward from the top surface of the device body.

The mixing device can include a controller and a user interface for selectively activating the plurality of magnetic drives in a cumulative operating mode wherein multiple magnetic drives operate simultaneously and a single operating mode wherein only a single magnetic drive is operating at one time.

In the single operating mode, the stirring bar can be magnetically attracted to the magnetic field generated by the active magnetic drive and can rotate around the central axis of the generated magnetic field to stir a liquid within a container positioned on the top surface of the device main body.

In the cumulative operating mode, each of the magnetic devices will generate individual magnetic fields, and a portion of the generated magnetic fields can overlap at a location surrounding the center of the device main body. In the cumulative operating mode, the stirring bar will be magnetically attracted to the overlapping magnetic field and can rotate around the central axis of the device extending from the center of the overlapping magnetic field to stir the liquid within the container.

In one embodiment, the controller can switch between the cumulative operating mode and the single operating mode to move the location of the stirrer within the liquid filled container.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a magnetic mixing system that is useful for understanding the inventive concepts disclosed herein.

FIG. 2 is a perspective view of the magnetic mixing device of the system in accordance with one embodiment of the invention.

FIG. 3 is a simplified block diagram of the system controller of the device, in accordance with one embodiment of the invention.

FIG. 4A is a top view of the device of the system in operation, in accordance with one embodiment of the invention.

FIG. 4B is perspective view of the system in operation in the cumulative operating mode, in accordance with one embodiment of the invention.

FIG. 5A is a perspective view of the system in operation in the single operating mode at a first routine, in accordance with one embodiment of the invention.

FIG. 5B is a perspective view of the system in operation in the single operating mode at a second routine, in accordance with one embodiment of the invention.

FIG. 5C is a perspective view of the system in operation in the single operating mode at a third routine, in accordance with one embodiment of the invention.

FIG. 5D is a perspective view of the system in operation in the single operating mode at a fourth routine, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Any element in a claim that does not explicitly state “means” for performing a specified function or “step” for performing a specified function should not be interpreted as a “means” or “step” clause as specified in 35 U.S.C. 112.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape, or measurement of a component within a tolerance such as, for example, manufacturing tolerances, measurement tolerances, or the like.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

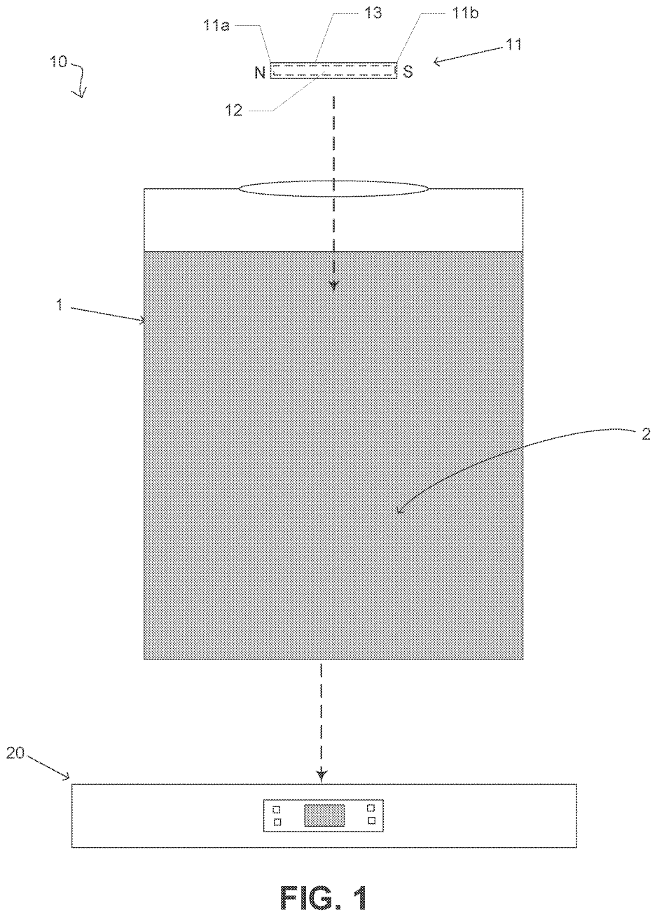

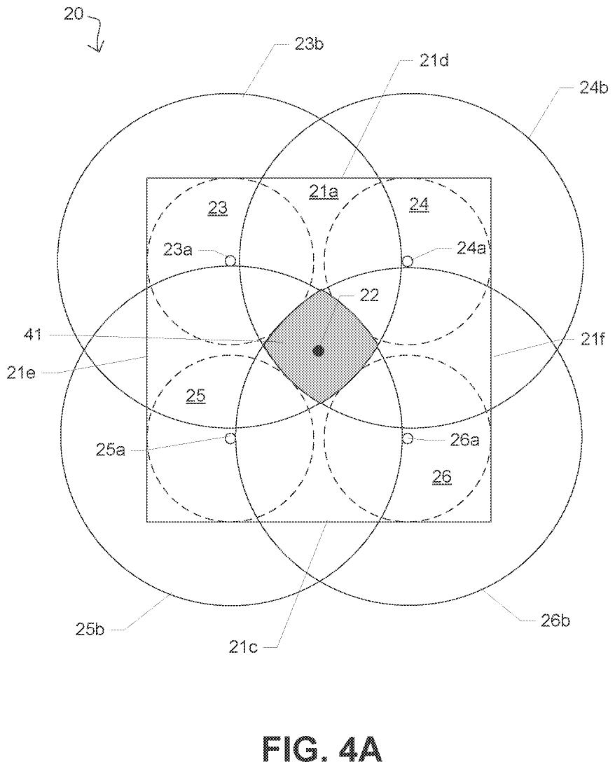

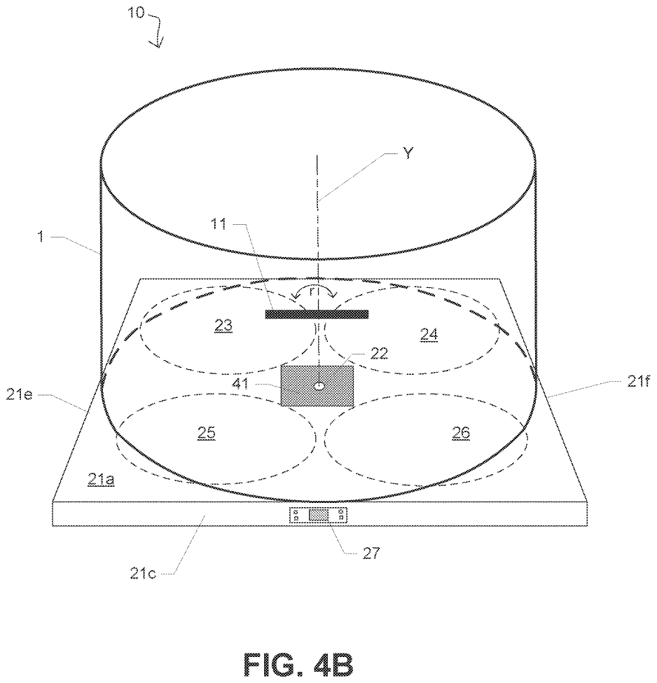

FIGS. 1-5D illustrate one embodiment of a magnetic mixing system for beverage containers 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 4B.

As shown best at FIG. 1, one embodiment of the system 10 can include a stirring bar 11 that is designed to be positioned within a beverage container 1, and a magnetic mixing device 20 that receives the container and rotates the stirring bar 11 to stir a beverage 2 within the container.

In one embodiment, the stirring bar 11 can include an elongated planar member having a central core 12 and a protective outer layer 13. In the preferred embodiment, the core 12 can include, comprise, or consist of a permanent magnet such as Alnico; Samarium Cobalt or Neodymium, for example, that generates a North Pole N along the first end of the bar 11a, and a South Pole S along the second end of the bar 11b. Of course, other embodiments are contemplated wherein the core 12 includes, comprises, or consists of a magnetically attractive metal such as Iron, Nickel, or Cobalt, for example.

The protective outer layer 13 of the stirring bar 11 is designed to ensure the core does not contaminate, alter, or otherwise interfere with the ingredients and chemistry of the beverage into which it is deposited. In this regard, the outer layer 13 can completely incapsulate the core, and can be constructed from any number of nonporous chemically inert materials such as PTFE, for example, that are suitable for being submerged within a variety of liquids for a prolonged period of time.

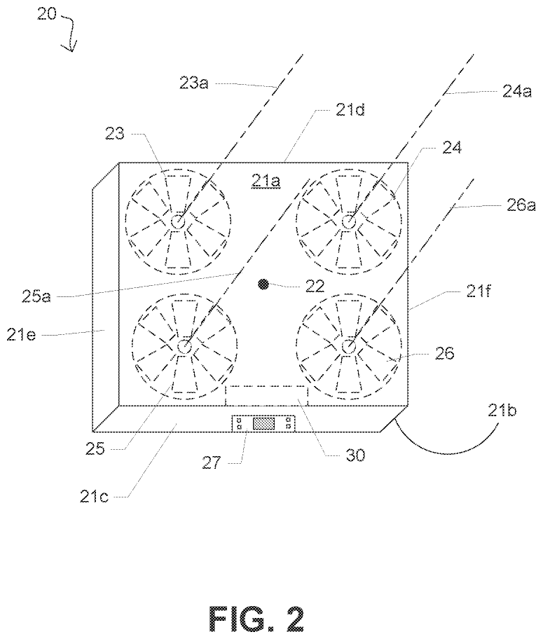

FIG. 2 illustrates one embodiment of the magnetic mixing device 20. As shown, the device can include a main body having a generally flat-top surface 21a, a bottom surface 21b, a front surface 21c, a back surface 21d and a pair of side surfaces 21e and 21f that define an interior space. The main body can be constructed from any number of strong and non-magnetically attractive materials such as aluminum, or metal alloys, for example; however other construction materials are also contemplated.

In one embodiment, a plurality of magnetic drives 23, 24, 25 and 26 can be positioned within the main body, and can each be connected to a central controller 30. In the preferred embodiment, each of the magnetic drives 23-26 can be positioned equidistant from the center 22 of the top surface 21a, and at offsetting 90-degree angles therefrom (i.e., positioned at 0°, 90°, 180° and 270° around the center 22).

As described herein, each of the magnetic drives 23-26 can include any number of devices capable of producing a magnetic field/flux having a central axis 23a-26a, respectively, that extends perpendicularly up from the top surface 21a of the main body (e.g., axial flux) so as to individually engage and rotate the stirring bar when the device is in operation. In the preferred embodiment, each of the magnetic drives 23-26 can include, comprise, or consist of a solid-state electromagnetic stator having a plurality of electromagnet coils which can be operated in sequence by the controller 30 to produce a rotating magnetic field about the respective central axis. This field crosses an air gap between the top surface of the device 21a and the location of the stirring bar 11 located within a beverage container which causes the stirring bar to rotate around the respective central axis.

Several nonlimiting examples of suitable axial flux stators are described in U.S. Pat. No. 3,786,325 to Tunnah; U.S. Pat. No. 12,415,167 to Even; and U.S. Patent Publication No. 2026/0005556 to Szekely, the contents of each of which are incorporated herein by reference. Of course, any number of other such devices are also contemplated.

In one embodiment, a user interface 27 can be provided along or can be connected to the main body. The user interface can include any number of components such as various buttons, knobs, display screens and/or touch screen displays capable of providing one way or two-way communication with a device user. The user interface can allow a user to control the operation of the device so as to transition the device between an ON and OFF operating state, and to control the speed at which the stirring bar spins within the container. Additionally, the user interface can allow a user to select specific intervals at which the device operates in each of the below described cumulative and single operating modes.

Although described above with regard to a particular type, number, or location of magnetic drives, this is for illustrative purposes only. To this end, other embodiments are contemplated wherein the device includes a different type, number, and/or location of magnetic drives.

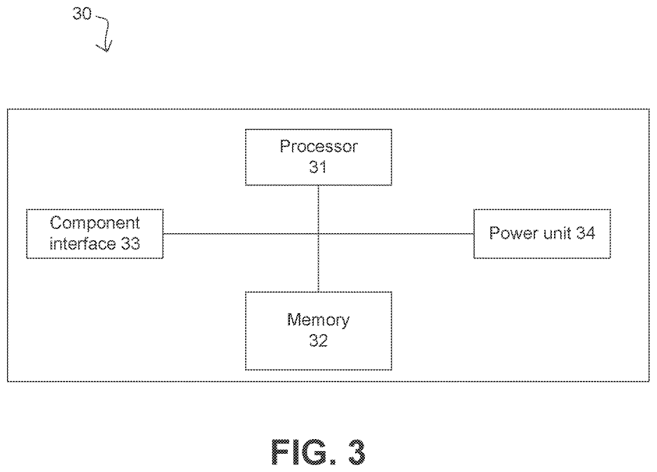

FIG. 3 is a simplistic block diagram illustrating one embodiment of the controller 30 that includes a processor 31, a memory 32, a component interface device 33, and a power unit 34.

Although illustrated as separate elements, those of skill in the art will recognize that one or more system controller components 31-34 may include, comprise, or consist of one or more printed circuit boards (PCB) containing any number of integrated circuits for completing the activities described herein. Of course, any number of other analog and/or digital components capable of performing the described functionality can be provided in place of, or in conjunction with the described elements.

The processing unit 31 can include one or more central processing units (CPU) or any other type of device, or multiple devices, capable of manipulating or processing information such as program code stored in the memory 32 in order to allow the device to perform the functionality described herein.

Memory 32 can act to store operating instructions in the form of program code for the processing unit 31 to execute. Although illustrated in FIG. 3 as a single component, memory 32 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device such as a solid-state hard drive, for example.

The component interface unit 33 can function to provide a communicative link between the processor 31, the user interface 27 and the plurality of magnetic drives 23-26. In this regard, the component interface unit can include any number of different components such as one or more PIC microcontrollers, standard bus, internal bus, connection cables, and/or associated hardware capable of allowing the device to operate in the manner herein described.

The power unit 34 can include any number of different components capable of providing the necessary power requirements to each element of the device 20. In the preferred embodiment, the power unit can include or comprise an A/C electrical power cord and transformer for allowing the device to be plugged into a standard electrical outlet. The transformer of the unit can step down the received power and any number of internal circuits, cables or other such components can provide the power to the respective device components.

FIGS. 4A and 4B illustrate one embodiment of the system 10 in operation. As shown below, the processor and memory of the controller 30 include functionality for selectively operating each of the magnetic drives 23-26 to produce a respective rotating magnetic field along its respective central axis. This functionality allows the device to operate in a single operating mode and a cumulative operating mode.

FIG. 4A illustrates one embodiment of the system in operation with the device 20 operating in a cumulative operating mode wherein multiple magnetic drives are operating at the same time. In one embodiment, each of the magnetic drives 23-26 can be operated at the same time to produce individual rotating magnetic fields 23b-26b that extend outward from their central axes 23a-26a, respectively. Owing to the precise orientation of the magnetic drives, the fields overlap at a location 41 surrounding the center point 22 of the device 20.

In one embodiment, when operating in the cumulative operating mode the drives 23-26 can function in pairs such as 23/26 and 24/25, for example, such that the North poles and South poles of each pair are synchronized within the overlapping area. For example, when pairs 23/26 present a North Pole within the overlapping area, pairs 24/25 can present a South Pole within the overlapping area. As the drives continue to produce rotating magnetic fields, the alternating poles from each subsequent drive will interact with the poles on each end of the stirring bar 11 which causes the bar to rotate directly above the center point 22 within the overlapping location 41.

As shown at FIG. 4B, when the container 1 housing a beverage and the stirring bar 11 is positioned onto the top surface 21a of the stand 20, the cumulative power of the overlapping fields 41 (which is several order of magnitudes stronger than any single magnetic field 23b-26b) pulls the stirring bar 11 into the field 41 from wherever it is located. As such, in this configuration, the device will automatically orient the stirring bar 11 along the central axis Y of the main body which extends directly up from the center point 22, and the magnetic fields produced by each of the magnetic drives 23-26 will continuously rotate (arrow r) the stirring bar around the central axis to impart a stirring motion onto a beverage stored within the container.

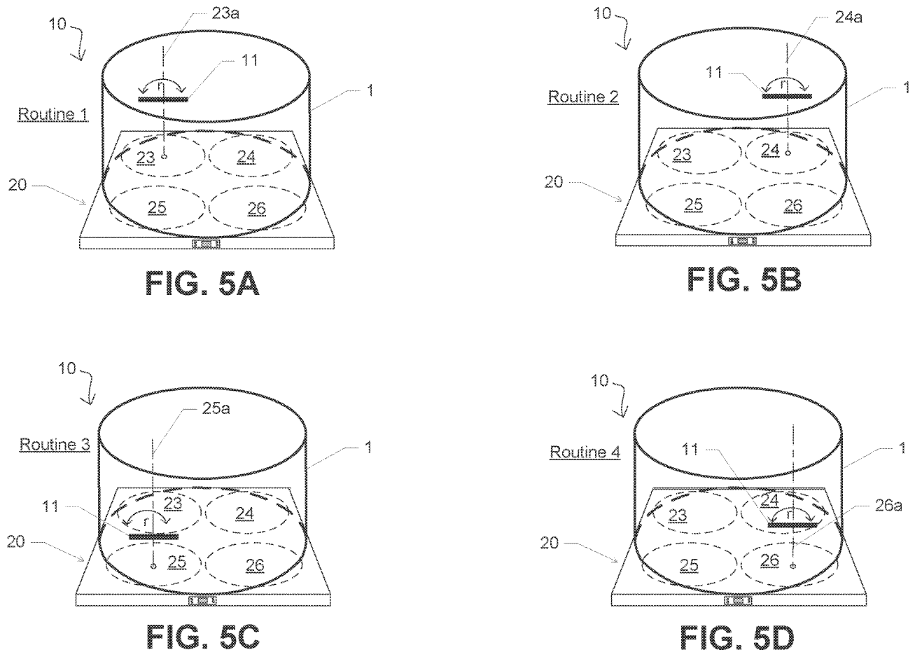

FIGS. 5A-5D illustrate one embodiment of the system 10 with the device 20 in the single operating mode. In one embodiment, when the device includes four magnetic drives, the system can include four distinct single operating mode operating routines 1, 2, 3 and 4 to selectively operate each single magnetic drive 23, 24, 25 and 26, respectively, by itself.

In this regard, each of the drives 23-26 can be individually activated to operate alone and to individually attract the stirring bar 11 into its respective magnetic field 23b-26b and to spin the stirring bar (arrow r) around its respective central axis 23-26.

In one embodiment, the system can move the stirring bar from operating with one magnetic drive to operate with a different magnetic drive by sequentially alternating the system between the cumulative operating mode and the single operating mode.

More specifically, when the system is operating in any of the routines 1-4 of the single operating mode shown at FIGS. 5A-5D and the system transitions to the cumulative operating mode, the previously inactive magnetic drives will become active to create the overlapping magnetic field 41 shown at FIG. 4A. This stronger overlapping magnetic field 41 pulls the stirring bar 11 into the center of the container where it rotates along the center axis as noted above.

Next, the system can transition to the single operating mode by maintaining one of the magnetic drives 23-26 in an active state and deactivating the rest. Because each of the magnetic drives produce the overlapping area 41 noted above, the stirring bar 11 will not lose magnetic attraction with the active drive and will instead be pulled toward the central axis 23a-26a of the active magnetic drive 23-26, respectively, where it will rotate to stir the beverage as shown at FIGS. 5A-5D.

In this regard, the controller can operate the system in each of the modes and routines for any number of different amounts of time such as 5 minutes, for example, which may be determined at a time of manufacture and/or may be selectable by the user via the interface device. This functionality is important as it ensures the system will continuously and thoroughly stir the beverage within the container by purposefully and accurately moving the stirring bar to different locations within the container itself while constantly spinning the stirring bar.

The ability of the device to operate in the cumulative drive configuration, and the functionality for automatically transitioning the device into the cumulative drive configuration between each single operating mode/routine is a critical aspect of the present invention, as it captures and positions the stirring bar in the center of the container regardless of where it was previously located.

As such, in instances where the stirring bar loses contact with any single magnetic drive when the device is operating in the single drive configuration, the stirring bar will be automatically captured and repositioned in the center of the container the next time the device switches to the cumulative operating mode. As such, the maximum period of time the system can go without actively stirring the beverage is equal to the maximum time any single magnetic drive operates in the single drive configuration.

Moreover, because the magnetic fields of the magnetic drives encompass the entire container, such a feature critically ensures that the stirring bar will not move to a position that is not affected by the magnetic fields and stop spinning, thus requiring a user to physically manipulate the container to realign the stirring bar with a magnetic field generator as was a known problem with existing systems.

Accordingly, the above noted system provides a device for continuously stirring beverages within a container by precisely moving and rotating a stirring bar within the container that eliminates the need to manually move the container to align the stirring bar with the magnetic fields generated by the mixing device.

Although described above with regard to use with a beverage container for stirring beverages, this is but one nonlimiting example. To this end, the system can be used to stir any type of material within any type of container. Additionally, although illustrated with regard to four magnetic drives operating at four routines, this is also for illustrative purposes, as the device can include any number of magnetic drives and can thus operate at any number of individual routines.

As to a further description of the manner and use of the present invention, the same should be apparent from the above description. Accordingly, no further discussion relating to the manner of usage and operation will be provided.

As described herein, one or more elements of the above noted device and system can be secured together utilizing any number of known attachment means such as, for example, screws, glue, compression fittings, and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

Any element in a claim that does not explicitly state “means” for performing a specified function or “step” for performing a specified function should not be interpreted as a “means” or “step” clause as specified in 35 U.S.C. 112. The corresponding structures, materials, acts, and equivalents of all means or step plus function elements in the claims below are intended to include any structure, material, or act for performing the function in combination with other claimed elements as specifically claimed.

The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system, comprising:
a mixing device having a main body that includes a top surface and an interior space;
a plurality of magnetic drives that are positioned within the interior space of the mixing device;
a controller that is positioned within the mixing device, said controller being in electronic communication with each of the plurality of magnetic drives; and
a stirring bar having a first end with a first magnetic pole, and a second end with a second magnetic pole,
wherein the top surface of the main body is configured to receive a liquid filled container, and
wherein the stirring bar is configured to be positioned within the container and to selectively move about the container to impart a stirring force onto the liquid.

2. The system of claim 1, wherein the stirring bar comprises:
an elongated member having a permanent magnetic core and a protective outer layer.

3. The system of claim 1, wherein the stirring bar is magnetically attracted to at least one of the plurality of magnetic drives and is configured to rotate around a central axis of the at least one magnetic drive.

4. The system of claim 1, wherein each of the plurality of magnetic drives are configured to generate a magnetic field that spans an air gap to impart a motion of rotation onto the stirring bar.

5. The system of claim 4, wherein the motion of rotation imparts the stirring force onto the liquid.

6. The system of claim 1, wherein each of the plurality of magnetic drives comprises a solid state electromagnetic stator.

7. The system of claim 6, wherein each of the plurality of magnetic drives produce an axial flux that extends perpendicularly from the top surface of the main body.

8. The system of claim 1, wherein the controller is configured to operate the mixing device in a cumulative operating mode wherein more than one of the plurality of magnetic drives are active at the same time.

9. The system of claim 1, wherein the controller is configured to operate the mixing device in a single operating mode wherein only one of the plurality of magnetic drives are active at one time.

10. The system of claim 1, further comprising:
a user interface device that is in communication with the controller, said device allowing a user to control an operation of each of the plurality of magnetic drives.
